(19) United States
(12) Patent Application Publication
(10) Pub. No.: US 2009/0300951 A1
(43) Pub. Date: Dec. 10, 2009

(54) GREETING CARD

(76) Inventor: Dehai WANG, Surrey (CA)

Correspondence Address: MATTHIAS SCHOLL, 14781 MEMORIAL DRIVE, SUITE 1319, HOUSTON, TX, 77079, US

(21) Appl. No.: 12/541,920

(22) Filed: Aug. 15, 2009

Related U.S. Application Data
(63) Continuation of application No. PCT/CN2008/072991, filed on Nov. 10, 2008.

(30) Foreign Application Priority Data
Mar. 31, 2008 (CN) 200820074248.2

(51) Int. Cl. G09F 1/04

(52) U.S. Cl. 40/124.06

(57) ABSTRACT

A greeting card, including at least a body having at least four surfaces including a front surface, two opposed inner surfaces and a back surface, a holder, and a decorating portion including multiple decorating sheets: the first decorating sheet, the second decorating sheet, . . . , the N^{th} decorating sheet, and a wire. The body is a folded sheet, a picture is disposed on the front surface of the body, one of the inner surfaces allows a user to write a greeting message thereon, the holder is disposed on the other one of the inner surfaces of the body and operates to receive the decorating portion, the first decorating sheet, the second decorating sheet, . . . , and the N^{th} decorating sheet each has a first suspension point disposed on an upper edge thereof, the first decorating sheet, the second decorating sheet, . . . , and the (N−1)^{th} decorating sheet each has a second suspension point disposed on one end thereof, the second suspension point of each of the first decorating sheet, the second decorating sheet, . . . , and the (N−1)^{th} decorating sheet is connected to the first suspension point of the next decorating sheet via the wire, and the first suspension point of each of the decorating sheets is within a center of gravity range thereof.

### CROSS-REFERENCE TO RELATED APPLICATIONS

This application is a continuation of International Patent Application No. PCT/CN2008/072991 with an international filing date of Nov. 10, 2008, designating the United States, now pending, and further claims priority benefits to Chinese Patent Application No. 200820074248.2 filed Mar. 31, 2008. The contents of all of the aforementioned applications, including any intervening amendments thereto, are incorporated herein by reference.

### BACKGROUND OF THE INVENTION

1. Field of the Invention

The invention relates to a greeting card.

2. Description of the Related Art

Greeting cards bearing a message of greeting, congratulation or other sentiment are usually sent or given on a special occasion or holiday. However, there is a non-neglectable problem with the conventional greeting cards: they lack exhibition and decorating effect.

### SUMMARY OF THE INVENTION

In view of the above-described problem, it is one objective of the invention to provide a greeting card that features festive exhibition and decorating effect.

To achieve the above objectives, in accordance with one embodiment of the invention, provided is a greeting card, comprising a body comprising a front surface and two opposed inner surfaces, a holder, and a decorating portion comprising multiple decorating sheets: the first decorating sheet, the second decorating sheet, . . . , the N^{th} decorating sheet, and a wire. The body is a folded sheet, a picture is disposed on the front surface of the body, one of the inner surfaces allows a user to write a greeting message thereon, the holder is disposed on the other one of the inner surfaces of the body and operates to receive the decorating portion, the first decorating sheet, the second decorating sheet, . . . , and the N^{th} decorating sheet each has a first suspension point disposed on an upper edge thereof, the first decorating sheet, the second decorating sheet, . . . , and the (N−1)^{th} decorating sheet each has a second suspension point disposed on one end thereof, the second suspension point of each of the first decorating sheet, the second decorating sheet, . . . , and the (N−1)^{th} decorating sheet is connected to the first suspension point of the next decorating sheet via the wire, and the first suspension point of each of the decorating sheets is within a center of gravity range thereof.

In a class of this embodiment, the decorating portion further comprises a fixing device.

In a class of this embodiment, the fixing device is connected to the first suspension point of the first decorating sheet via the wire.

In a class of this embodiment, the wire sequentially passes through the fixing device, the first point of the first decorating sheet, the second point of the first decorating sheet, . . . , and the first point of the N^{th} decorating sheet.

In a class of this embodiment, the fixing device is an adhesive paper or a hanging ring.

In a class of this embodiment, colors or patterns are disposed on both sides of the decorating sheet.

In accordance with another embodiment of the invention, provided is a greeting card, comprising a body comprising a front surface and two opposed inner surfaces, a holder, and a decorating portion comprising multiple decorating sheets: the first decorating sheet, the second decorating sheet, . . . , the N^{th} decorating sheet, and multiple wires. The body is a folded sheet, a picture is disposed on the front surface of the body, one of the inner surfaces allows a user to write a greeting message thereon, the holder is disposed on the other one of the inner surfaces of the body and operates to receive the decorating portion, the first decorating sheet, the second decorating sheet, . . . , and the N^{th} decorating sheet each has a first suspension point disposed on an upper edge thereof, the first decorating sheet, the second decorating sheet, . . . , and the (N−1)^{th} decorating sheet each has a second suspension point disposed on one end thereof, the second suspension point of each of the first decorating sheet, the second decorating sheet, . . . , and the (N−1)^{th} decorating sheet is connected to the first suspension point of the next decorating sheet via the wire, and the first suspension point of each of the decorating sheets is within a center of gravity range thereof.

In a class of this embodiment, the decorating portion further comprises a fixing device.

In a class of this embodiment, the fixing device is connected to the first suspension point of the first decorating sheet via the wire.

In a class of this embodiment, one of the wires operates to connect the fixing device and the first point of the first decorating sheet.

In a class of this embodiment, the rest of the wires are connected between the second suspension point of each of the first decorating sheet, the second decorating sheet, . . . , and the (N−1)^{th} decorating sheet and the first suspension point of the next decorating sheet.

In a class of this embodiment, the fixing device is an adhesive paper or a hanging ring.

In a class of this embodiment, colors or patterns are disposed on both sides of the decorating sheet.

Advantages of the invention comprise: 1) the picture on the front surface of the body, the greeting message on one of the inner surfaces, and the colors or the patterns on the decorating sheets facilitate information transfer and emotion exchange; 2) since the first suspension point of each of the decorating sheets is within a center of gravity range thereof, a stable structure is formed after the decorating sheets are unfolded; and 3) the greeting card looks like a suspended structure and the decorating sheets are capable of freely rotating in a range of 360 degree, which improves decorating and exhibition effect of the invention.

### BRIEF DESCRIPTION OF THE DRAWINGS

The invention is described hereinafter with reference to accompanying drawings, in which:

FIG. 1 is a front view of a front surface of a body of a greeting card of an embodiment of the invention;

FIG. 2 is a front view of two inner surfaces of a body of a greeting card of an embodiment of the invention;

FIG. 3 is a schematic view of a decorating portion of a greeting card of an embodiment of the invention;

FIG. 4 is a top view of a decorating portion of a greeting card of another embodiment of the invention; and

FIG. 5 is a schematic view of a decorating portion of a greeting card of another embodiment of the invention.

In which: 1—body; 2—picture; 3—holder; 4—decorating portion; 5—decorating sheet; 6—wire; 7—first suspension point; 8—second suspension point; 9—fixing device.

### DETAILED DESCRIPTION OF THE EMBODIMENTS

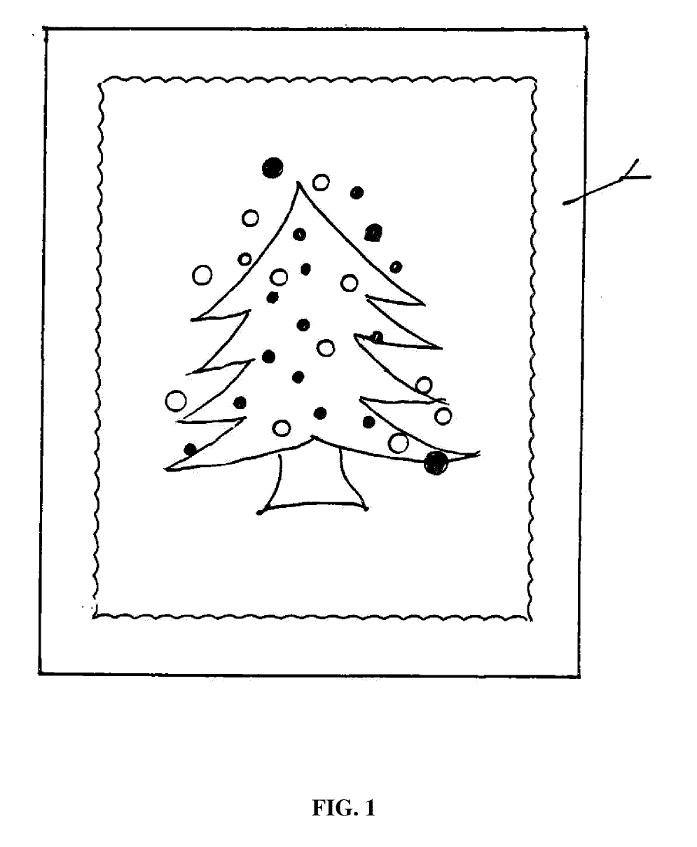

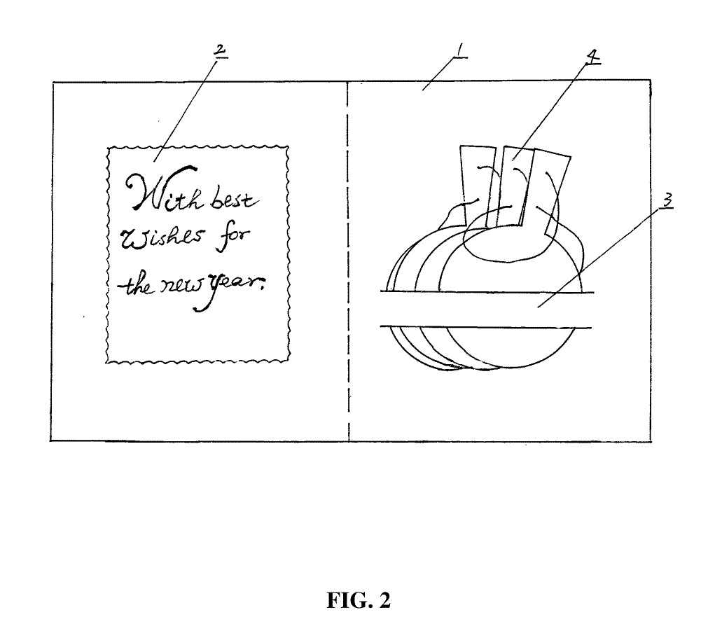

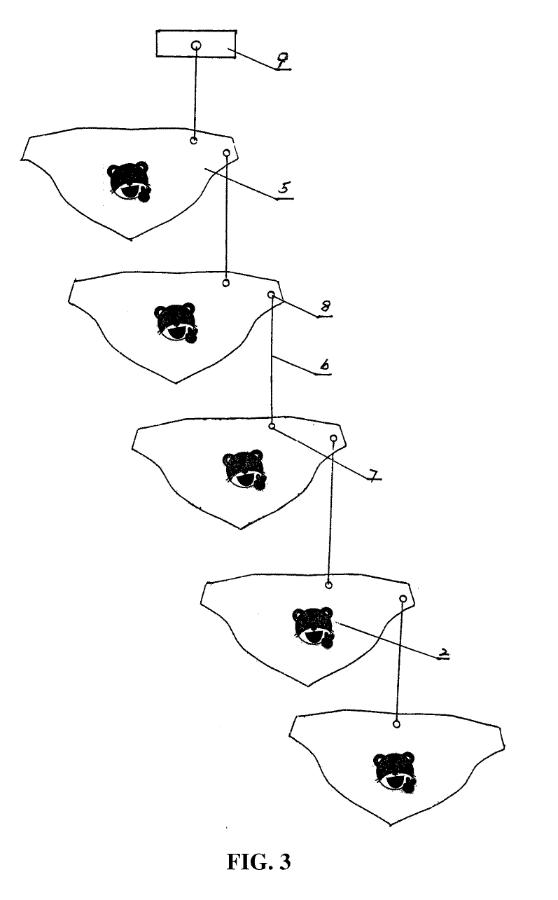

As shown in FIGS. 1-3, a greeting card of an embodiment of the invention comprises a body 1, a holder 3, and a decorating portion 4.

The body 1 has at least four surfaces comprising a front surface, two opposed inner surfaces and a back surface. The body 1 is a folded sheet, a picture 2 is disposed on the front surface of the body 1, and one of the inner surfaces allows a user to write a greeting message thereon.

The decorating portion 4 comprises multiple decorating sheets 5, multiple wires 6 and a fixing device 9. In this embodiment, the decorating portion 4 comprises five decorating sheets 5: the first decorating sheet, the second decorating sheet, . . . , and the fifth decorating sheet, and the number of the wires 6 is 5.

The first decorating sheet, the second decorating sheet, . . . , and the fifth decorating sheet each has a first suspension point 7 disposed on an upper edge thereof.

The first decorating sheet, the second decorating sheet, . . . , and the fourth decorating sheet each has a second suspension point 8 disposed on one end thereof.

The second suspension point of each of the first decorating sheet, the second decorating sheet, . . . , and the fourth decorating sheet is connected to the first suspension point of the next decorating sheet 5 via the wire 6. In details, a first wire connects the fixing device 9 and the first suspension point 7 of the first decorating sheet, a second wire is connected between the second suspension point 8 of the first decorating sheet and the first suspension point 7 of the second decorating sheet, a third wire is connected between the second suspension point 8 of the second decorating sheet and the first suspension point 7 of the third decorating sheet, . . . , and so on.

The first suspension point 7 of each of the decorating sheets 5 is within a center of gravity range thereof.

The fixing device 9 is connected to the first suspension point 7 of the first decorating sheet via the wire 6. In this embodiment, the fixing device 9 is an adhesive paper or a hanging ring.

The holder 3 is disposed on the other one of the inner surfaces of the body 1 and operates to receive the decorating portion 4.

Colors or patterns are disposed on both sides of the decorating sheet 5.

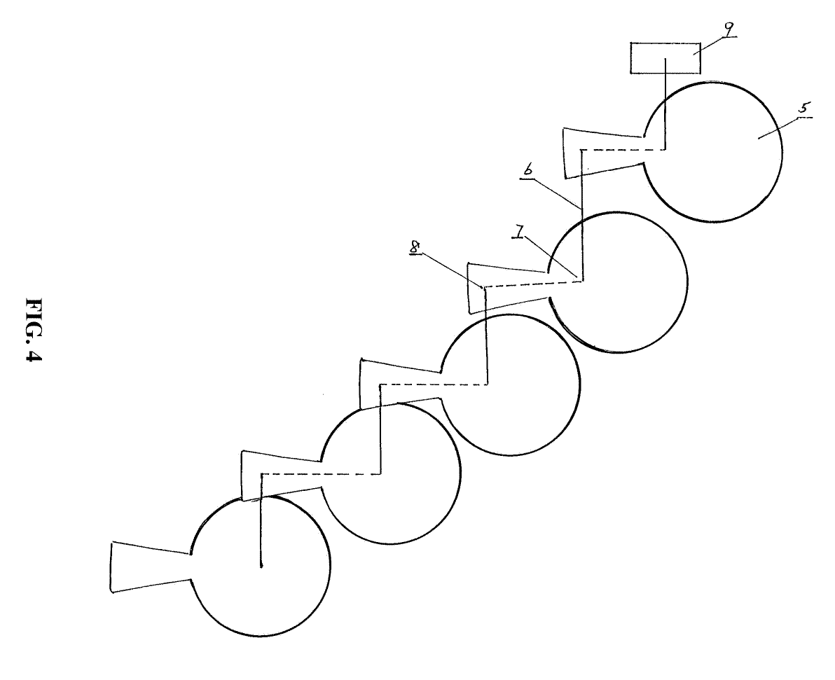

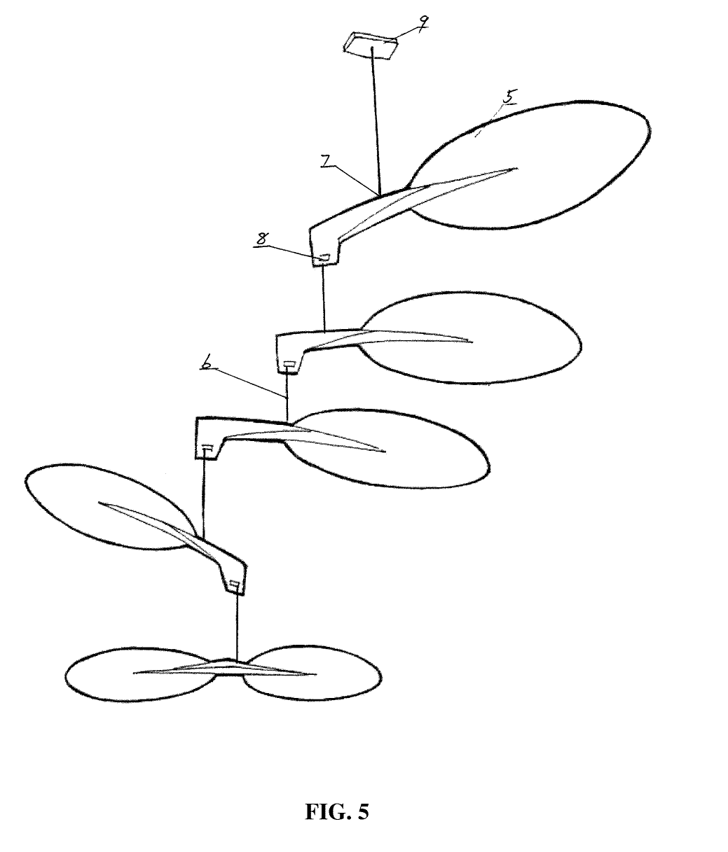

As shown in FIGS. 4 and 5, a greeting card of another embodiment of the invention comprises a body 1, a holder 3, and a decorating portion 4.

The body 1 has at least four surfaces comprising a front surface, two opposed inner surfaces and a back surface. The body 1 is a folded sheet, a picture 2 is disposed on the front surface of the body 1, and one of the inner surfaces allows a user to write a greeting message thereon.

The decorating portion 4 comprises multiple decorating sheets 5, a wire 6 and a fixing device 9. In this embodiment, the decorating portion 4 comprises five decorating sheets 5: the first decorating sheet, the second decorating sheet, . . . , and the fifth decorating sheet.

The first decorating sheet, the second decorating sheet, . . . , and the fifth decorating sheet each has a first suspension point 7 disposed on an upper edge thereof.

The first decorating sheet, the second decorating sheet, . . . , and the fourth decorating sheet each has a second suspension point 8 disposed on one end thereof.

The second suspension point of each of the first decorating sheet, the second decorating sheet, . . . , and the fourth decorating sheet is connected to the first suspension point of the next decorating sheet 5 via the wire 6. In details, the wire 6 sequentially passes through the fixing device 9, the first point 7 of the first decorating sheet, the second point 8 of the first decorating sheet, . . . , and the first point 7 of the fifth decorating sheet.

The first suspension point 7 of each of the decorating sheets 5 is within a center of gravity range thereof.

The fixing device 9 is connected to the first suspension point 7 of the first decorating sheet via the wire 6. In this embodiment, the fixing device 9 is an adhesive paper or a hanging ring.

The holder 3 is disposed on the other one of the inner surfaces of the body 1 and operates to receive the decorating portion 4.

Colors or patterns are disposed on both sides of the decorating sheet 5.

In use, after attach the fixing device 9 to the top of a house, the decorating sheets 5 are unfolded and form a suspended structure, and the decorating sheets 5 are capable of freely rotating in a range of 360 degree, which improves decorating and exhibition effect of the greeting card. Moreover, the picture on the front surface of the body 1, the greeting message on one of the inner surfaces of the body 1, and the colors or patterns on the decorating sheets 5 facilitate information transfer and emotion exchange.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A greeting card, comprising
a body comprising a front surface and two opposed inner surfaces;
a holder; and
a decorating portion comprising multiple decorating sheets: the first decorating sheet, the second decorating sheet, . . . , the N^{th} decorating sheet, and a wire;
wherein
said body is a folded sheet;
a picture is disposed on said front surface of said body;
one of said inner surfaces allows a user to write a greeting message thereon;
said holder is disposed on the other one of said inner surfaces of said body and operates to receive said decorating portion;
said first decorating sheet, said second decorating sheet, . . . , and said N^{th} decorating sheet each has a first suspension point disposed on an upper edge thereof;
said first decorating sheet, said second decorating sheet, . . . , and said (N−1)^{th} decorating sheet each has a second suspension point disposed on one end thereof;
said second suspension point of each of said first decorating sheet, said second decorating sheet, . . . , and said (N−1)^{th} decorating sheet is connected to said first suspension point of the next decorating sheet via said wire; and
said first suspension point of each of said decorating sheets is within a center of gravity range thereof.

2. The greeting card of claim 1, wherein said decorating portion further comprises a fixing device.

3. The greeting card of claim 2, wherein said fixing device is connected to said first suspension point of said first decorating sheet via said wire.

4. The greeting card of claim 2, wherein said wire sequentially passes through said fixing device, said first point of said first decorating sheet, said second point of said first decorating sheet, . . . , and said first point of said N^{th} decorating sheet.

5. The greeting card of claim 2, wherein said fixing device is an adhesive paper or a hanging ring.

6. The greeting card of claim 1, wherein colors or patterns are disposed on both sides of said decorating sheets.

7. A greeting card, comprising
a body comprising a front surface and two opposed inner surfaces;
a holder; and
a decorating portion comprising multiple decorating sheets: the first decorating sheet, the second decorating sheet, . . . , the N^{th} decorating sheet, and multiple wires;
wherein
said body is a folded sheet;
a picture is disposed on said front surface of said body;
one of said inner surfaces allows a user to write a greeting message thereon;
said holder is disposed on the other one of said inner surfaces of said body and operates to receive said decorating portion;
said first decorating sheet, said second decorating sheet, . . . , and said N^{th} decorating sheet each has a first suspension point disposed on an upper edge thereof;
said first decorating sheet, said second decorating sheet, . . . , and said (N−1)^{th} decorating sheet each has a second suspension point disposed on one end thereof;
said second suspension point of each of said first decorating sheet, said second decorating sheet, . . . , and said (N−1)^{th} decorating sheet is connected to said first suspension point of the next decorating sheet via said wire; and
said first suspension point of each of said decorating sheets is within a center of gravity range thereof.

8. The greeting card of claim 7, wherein said decorating portion further comprises a fixing device.

9. The greeting card of claim 8, wherein said fixing device is connected to said first suspension point of said first decorating sheet via said wire.

10. The greeting card of claim 9, wherein one of said wires operates to connect said fixing device and said first point of said first decorating sheet.

11. The greeting card of claim 10, wherein the rest of said wires are connected between said second suspension point of each of said first decorating sheet, said second decorating sheet, . . . , and said (N−1)^{th} decorating sheet and said first suspension point of the next decorating sheet.

12. The greeting card of claim 8, wherein said fixing device is an adhesive paper or a hanging ring.

13. The greeting card of claim 7, wherein colors or patterns are disposed on both sides of said decorating sheets.
